(19) United States
(12) Patent Application Publication
(10) Pub. No.: US 2014/0364178 A1
(43) Pub. Date: Dec. 11, 2014

(54) RIGID FRAME WITH PROTECTIVE FILM

(71) Applicant: Speculative Product Design, LLC, San Mateo, CA (US)

(72) Inventors: Bryan Hynecek, Redwood City, CA (US); Bryan Day, San Jose, CA (US)

(21) Appl. No.: 14/298,700

(22) Filed: Jun. 6, 2014

Related U.S. Application Data
(60) Provisional application No. 61/832,019, filed on Jun. 6, 2013.

(51) Int. Cl. H04B 1/38; H04M 1/02

(52) U.S. Cl. CPC H04B 1/3888; H04M 1/0202
USPC 455/575.8

(57) ABSTRACT

A screen protector with a screen protective film and an integrated frame configured to be attached to the screen of an electronic device. The screen protector is a lightweight screen cover that provides impact protection and personalization to any device.

### CROSS-REFERENCE TO RELATED APPLICATIONS

The present application is a non-provisional application claiming priority to U.S. Provisional Patent Application No. 61/832,019 filed Jun. 6, 2013 entitled RIGID FRAME WITH PROTECTIVE FILM the entirety of which is incorporated by reference herein.

### BACKGROUND OF THE INVENTION

Portable electronic devices have become commonplace in today's world. Examples of popular portable electronic devices include mobile phones, smartphones, tablets, digital music players, satellite radios, in-vehicle displays, still and/or video cameras, laptops, navigation devices, and so forth. Such devices allow users to make phone calls, store and play music, videos, and pictures, send and receive email and texts, manage appointments, access the Internet, and a host of other things. Many of the available devices have large screens that enhance the user's viewing area as well as act as an interface area though the use of a capacitance, pressure, or other type of touch interfaces. As a result, users interact frequently through the screen of their device. To facilitate such interaction, the screen is usually composed of transparent glass, plastic, or other material.

Due to the portability of these devices, they are subject to a significant amount of wear over their useful lifetime. This wear may become apparent on the transparent surfaces of the device's interface. In some cases, the devices may be damaged due to one-time events such dropping or contacting the device with a sharp object such as keys, rocks, etc.

Protective films are widely used for protecting electronic devices such as a Smartphone, tablet computers, computers with touch screen displays, and other screen or display devices. The protective films usually includes a transparent layer and an adhesive layer formed on the transparent layer. When in use, the protective film is attached to a screen through the adhesive layer and remains in place until it is replaced.

Protective films may offer a variety of functionalities. However, the protective film may be difficult to apply to the electronic device, may require professional installations, and/or may not result in a film that is invisible to the user. For example, while installing a protective film on an electronic device, visible air bubbles or dust particles may be formed between the protective film and the screen of the electronic device, especially when adhesive is used to statically adhere the protective film to the screen of the electronic device. Moreover, in some instances, the protective film may be not removable, and/or reusable. It is often the case that when applying the film, it must be repositioned several times before it aligns properly with the device. The repeated positioning of the film may result in an increase in contact with the adhesive side resulting in trapped dirt and dust particles and air.

Therefore, an unaddressed need exists in the art for a protective film that is easy to install, provides the desired level of protection, aligns easily, is reusable and removable and provides the user with the desired end result.

### SUMMARY OF THE INVENTION

In one embodiment, the present invention is directed to a screen protective film with an integrated frame configured to be attached to the screen of an electronic device. In another embodiment of the invention, the frame and screen are removable. In another embodiment, the screen protector is a lightweight screen cover that provides impact protection and personalization to any device. In an embodiment, the screen cover/protector consists of a film attached to a rigid frame with integrated button. In an embodiment, the cover employs a rigid frame that makes the application onto the device easier by the user. In an embodiment, the molded frame also allows color matching to the user's case. In an embodiment, the frame may be include an integrated button allowing the user to easily interface with the device. In an embodiment, the screen protector will be applied to the device screen using an adhesive. In another embodiment, the screen protector will be applied to the device with a liquid adhesive. In an embodiment, the adhesive will be applied in a manner that avoids the display portion of the device screen, making the screen protector easier to apply and avoiding bubbles or debris being trapped.

### BRIEF DESCRIPTION OF THE DRAWINGS

FIG. 1 depicts a view of protective film and frame in accordance with an embodiment of the present disclosure.

FIG. 2 depicts a series of protective frames with films in accordance with an embodiment of the present disclosure.

FIGS. 3A-3B depicts the edge detail of a frame with a device case in accordance with an embodiment of the present disclosure.

FIGS. 4A-B depicts a cross sectional view of a sketch of a frame with a protective film installed on an electronics device in accordance with an embodiment of the present disclosure.

### DETAILED DESCRIPTION

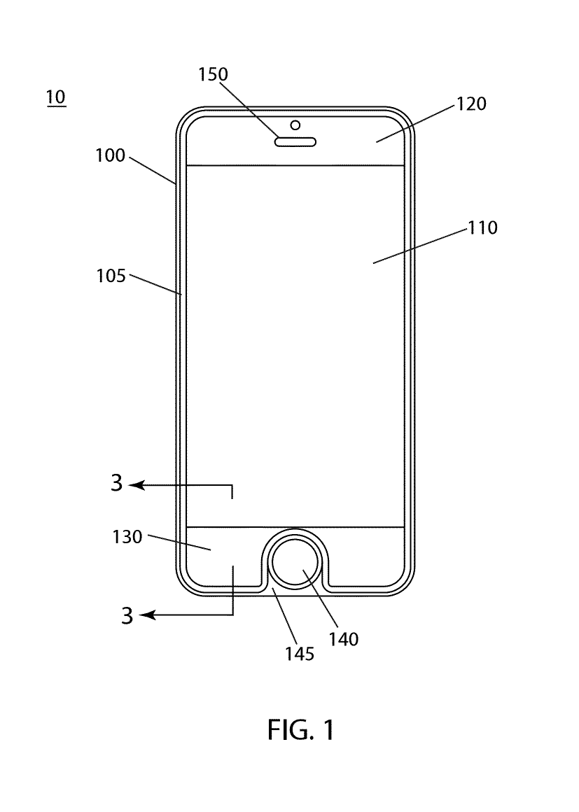

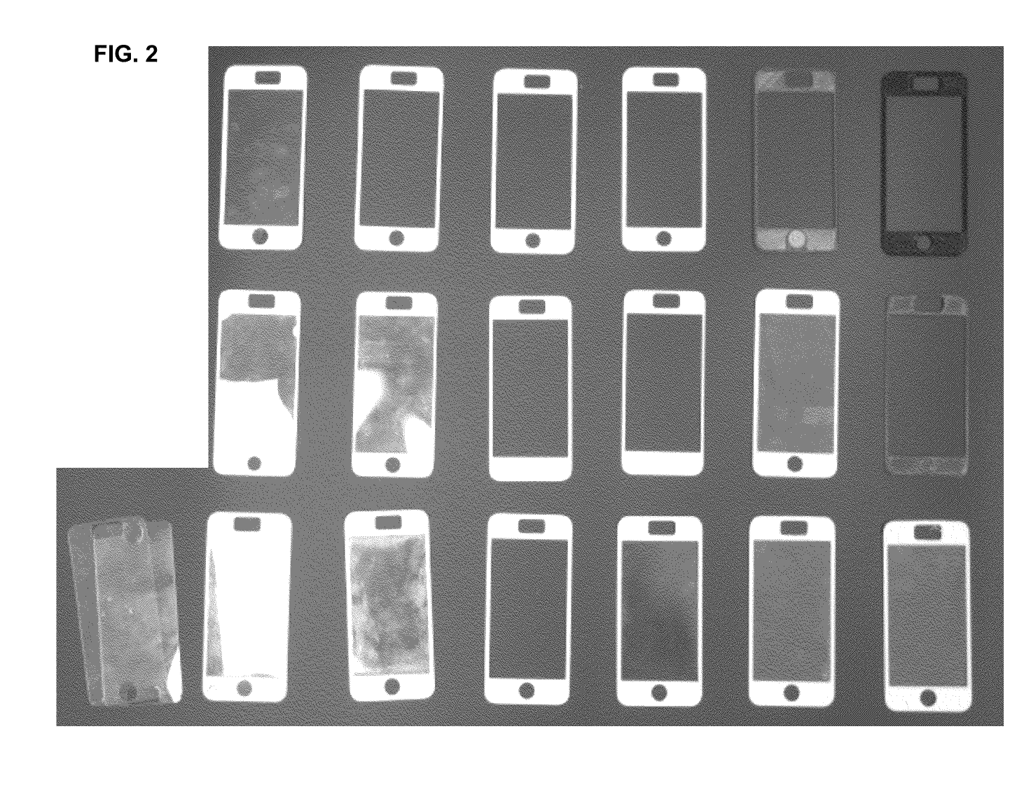

FIG. 1 depicts an embodiment of a screen protector in the form of a protective frame 10. Protective frame 10 comprises a frame 100 with protective film 110, frame areas 120 and 130, button 140 and aperture 150.

Protective frame 10 may be designed and manufactured to fit/mate or otherwise attach directly to a personal electronic device, such as a Smartphone. The protector can be applied to a device with a case as well as in, a stand-alone configuration. Frame 100 may comprise a contoured or beveled edge 105 that allows it to be retained on the exposed screen area of the device while protected by a case. The edge may comprise a spline, a bevel, a half round, quarter round, ogee, “c”, or any other profile that will allow it to interface with the device with or without a case. Frame 100 may be manufactured by any known molding technique including but not limited to injection molding, multi-shot molding, pouring, casting, stamping, CNC-ing, die-cutting, laser cutting, or any other known molding technique. It may be composed of one material or one part or may comprise an underlying frame made from several parts with a second material that is co-molded, over molded, or otherwise molded together with the underlying frame. Frame 100 may be composed of a molded plastic, such as a PC, ABS, PP, or a polymer or metal.

Protective frame 10 may be removable from the device upon which it is installed and may be cleanable. Similarly, the adhesive between protective frame 10 and the device may also be reusable and/or cleanable to restore tackiness. Furthermore, protective frame 10 provides impact protection via the frame 100 or bezel, the devices buttons may be protected by a rubber over layer 140 and the screen itself is protected by the protective film area 110.

Protective film area 110 may be transparent, opaque or polarized. It is intended to protect the underlying surface of the device while still allowing the user to view and access the underlying content and to control the device. Plastic film area 110 may be comprised of a clear plastic film such as PMMA, PET, or other plastics, glass and/or various polymers and may be between 0.1 mm-4.0 mm in thickness. If it is intended to be used with a capacitance type interface it should be capable of transferring a charge from the user to the device.

Film 110 has an outer surface and an inner surface wherein the inner surface may contain an adhesive such as silicone, vinyl, micro-suction or any other suitable adhesive. Adhesive may be applied to the entire inner surface of film 110 or may be placed only at select locations on the inner surface, such as areas 120 and 130. By applying adhesive only in areas not directly in contact with the visible screen area, no trapped air bubbles can form under the film which may obscure the viewing screen (which is a common problem with other known screen protectors). Adhesive may be applied during assembly or manufacturing or may be applied by the end user. Adhesive may be liquid or dry. Protective film 110 may be attached to frame 100 using chemical bonding, adhesives, heat, press fitting, ultrasonic welding, over-molding, insert-molding, co-molding, other molding techniques where materials are molded together, or any known molding or bonding method. It may be attached in a single step or may be applied in multiple steps. It may be made of the same materials as frame 100 or protective film 110 may be made from a different material. Protective film 110 may be supplied as sheet goods or may be molded along with other components of protective frame 10.

Frame areas 120 and 130 may be transparent, opaque or tinted solid and align with non-viewing areas of the screen on the underlying device. They may contain graphics, logos or may be color matched to replicate the underlying surfaces they cover. They may protect the surface of the underlying device. The coloration may be applied prior to affixing film 110 to frame 100 or may be applied once assembled. The color may be integral to the film or may be applied to either the inner or outer surface by any known means such as screening, printing, digital printing, in-mold decoration, over-mold decoration, water-transfer, or any known techniques. Frame areas 120 and 130 may have adhesive applied to their inner surface and may be used to adhere protective film 110 to the underling surface of the device.

Button 140 of protective frame 10 may align with an underlying button on the face of the device such as the Apple® iPhone or iPod devices and provides additional protection for the underlying device. Prior protective films do not provide any protection in the areas of underlying buttons but instead utilize a cut away area around the button. This creates an additional seam and area where contaminates and air may be trapped. Button 140 may be composed of TPE or TPU or any type of flexible molded rubber, plastic, and/or polymers and may be manufactured utilizing any known techniques. Button 140 may be manufactured concurrently with frame 100 using chemical bonding, adhesives, heat, press fitting, ultrasonic welding, over-molding, insert-molding, co-molding or any other known technique. Button 140 may be manufactured directly within film 110 or may be manufactured separately utilizing such techniques as injection molding, over-molding, compression molding, and bonded utilizing any known techniques including but not limited to chemical, heat, adhesive, ultra-sonic welding, pressure fit, ultrasonic welding, over-molding, insert-molding, co-molding or any other known methods. Button 140 may be located within the perimeter of frame 100 or may be located exterior to the perimeter of frame 100. Button 140 may be surrounded by a membrane 145 made of the same or different materials as the protective film 110. Membrane 145 may be molded from the same or different materials then either frame 100, protective film 110 or button 140.

Aperture 150 in film 110 may be positioned to align with a speaker, ear piece, mouth pieces or other area of the personal electronic device that requires an opening. Apertures 150 may be cut, utilizing any known cutting techniques including heat, punching, chemical etching, knives, or pressure.

FIG. 2 depicts a series of frames with protective films in accordance with an embodiment of the present disclosure.

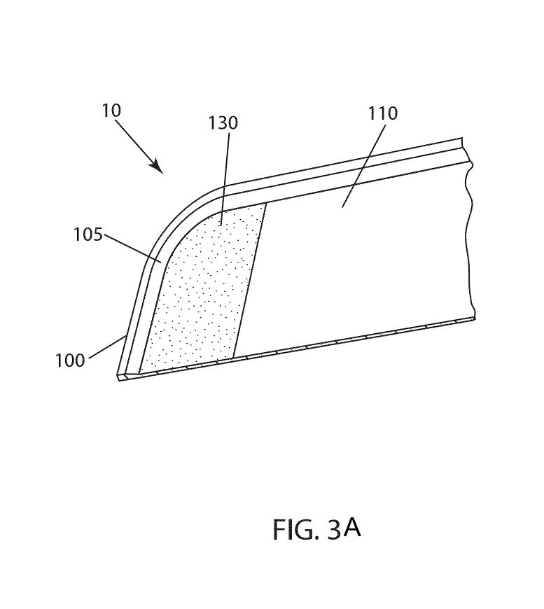

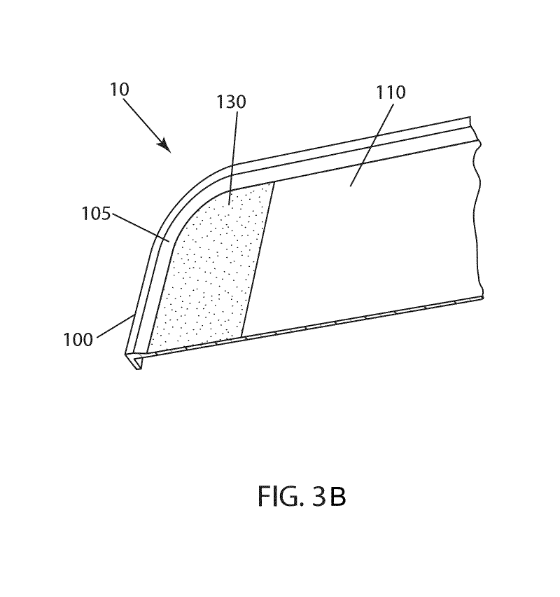

FIGS. 3A-3B depict a cross sectional view of protective frame 10 installed on a personal electronic device (PED) 20. Frame 100 may interface with a surrounding edge of PED 20 or may interface with a case installed on device 20.

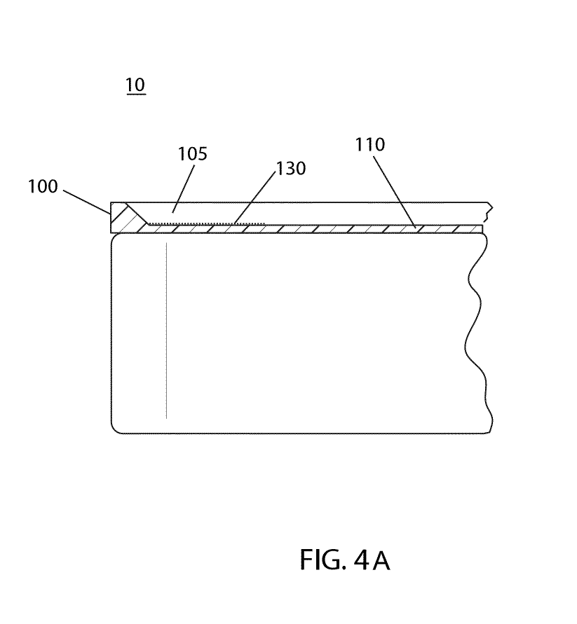

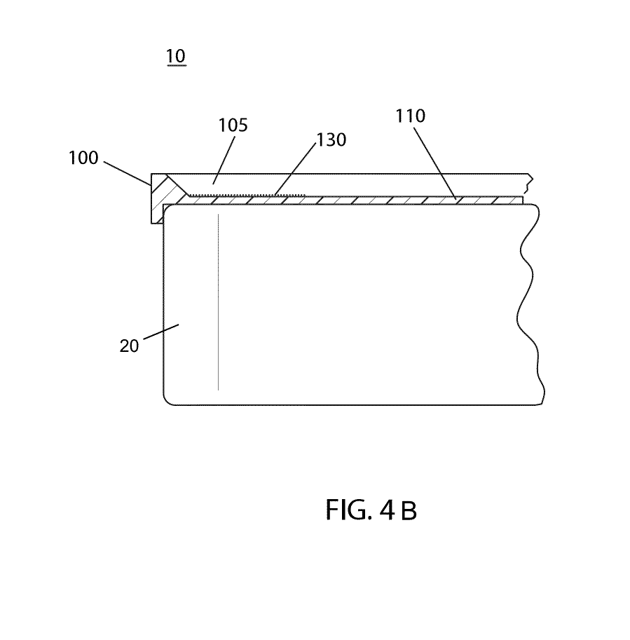

FIGS. 4A-4B depicts a cross sectional view of protective frame 10 installed on a personal electronic device (PED) 20. Frame 100 may interface with a surrounding edge of PED 20 or may interface with a case installed on device 20.

1. A screen protector for a personal electronic device comprising:
a frame;
a protective film, and
a button,
wherein the protective film is coupled to an interior portion of the frame and the button is coupled to an exterior portion of the frame.

2. The screen protector of claim 1, wherein the frame comprises:
a contoured or beveled edge configured to be retained on an exposed screen area of the personal electronic device when protected by a case for the personal electronic device.

3. The screen protector of claim 2, wherein the edge may comprises a profile shaped such that the screen protector can interface with the personal electronic device when protected by the case for the personal electronic device.

4. The screen protector of claim 3, wherein the profile shape comprises a shape selected from the group of: a spline, a bevel, a half round, a quarter round, an ogee, and a “c” shape.

5. The screen protector of claim 1, wherein the frame is made from only one material or one part.

6. The screen protector of claim 1, wherein the frame comprises:
an underlying frame made from one or more parts; and
a material that is co-molded, over molded, or otherwise molded together with the underlying frame.

7. The screen protector of claim 1, wherein the frame is configured to be removable.

8. The screen protector of claim 1, wherein the screen protector provides impact protection by comprising at least one of:
the frame being configured to provide impact protection via a beveled or contoured edge; and
the screen protector comprising a rubber cover layer positioned to the cover at least one button of the personal electronic device.

9. The screen protector of claim 1, wherein the protective film is from about 0.1 mm to about 4.0 mm in thickness.

10. The screen protector of claim 1, wherein the protective film comprises:
an outer surface
an inner surface, and
an adhesive applied to the entire inner surface of the protective film.

11. The screen protector of claim 1, wherein the protective film comprises:
an outer surface and
an inner surface,
an adhesive applied to locations on the inner surface of the protective film that are not in contact with the visible screen area of the personal electronic device.

12. The screen protector of claim 1, wherein the protective film comprises a capacitive material configured to transfer a charge from a user to the personal electronic device.

13. The screen protector of claim 1, wherein protector comprises:
the button of the protective frame being configured to align with and overlay a button on a face of the personal electronic device.

14. The screen protector of claim 1, wherein button comprises a material selected from the group of: a flexible molded rubber, plastic, and a polymer.

15. The screen protector of claim 14 wherein the button comprises material selected from the group of thermoplastic elastomers (TPE) or thermoplastic polyurethanes (TPU).

16. The screen protector of claim 1 wherein the button is located within a perimeter of the frame.

17. The screen protector of claim 1 wherein the button is located in a position exterior to a perimeter of the frame.

18. The screen protector of claim 1 wherein the screen protector comprises a membrane surrounding the button.

19. The screen protector of claim 18 wherein the membrane surrounding the button comprises a material that is the same as that of at least one of the frame, the protective film, or the button.

20. The screen protector of claim 18 wherein the membrane surrounding the button comprises a material that different from that of at least one of the frame, the protective film, or the button.

21. A method of making a screen protector for a personal electronic device, the method comprising:
coupling a protective film to an interior portion of a frame; and
coupling a button to an exterior portion of the frame.

22. The method of making the screen protector for a personal electronic device of claim 21, the method further comprising:
manufacturing the frame; and
manufacturing the button concurrently with frame.

22. The method of making the screen protector for a personal electronic device of claim 21, the method further comprising:
manufacturing the button directly within the protective film.

23. The method of making the screen protector for a personal electronic device of claim 21, the method further comprising:
manufacturing the button separately from the protective film.

24. The method of making the screen protector for a personal electronic device of claim 21, the method further comprising:
applying an adhesive to the entire inner surface of the protective film.

25. The method of making the screen protector for a personal electronic device of claim 21, the method further comprising:
applying the adhesive to locations on the inner surface that are not in contact with the visible screen area of the personal electronic device.
